(19) United States
(12) Patent Application Publication
(10) Pub. No.: US 2004/0116069 A1
(43) Pub. Date: Jun. 17, 2004

(54) System and method for recording and playing back music or data while tuned to satellite radio and karaoke system employing the same

(75) Inventors: Jalil Fadavi-Ardekani, Newport, CA (US); Edwin A. Muth, Aberdeen, NJ (US); Stefan Thurnhofer, Newport Beach, CA (US); Brijesh M. Tripathi, Whitehall, PA (US)

Correspondence Address: HITT GAINES P.C., P.O. BOX 832570, RICHARDSON, TX, 75083, US

(73) Assignee: Agere Systems Incorporated, Allentown, PA

(21) Appl. No.: 10/700,286

(22) Filed: Nov. 3, 2003

Related U.S. Application Data
(60) Provisional application No. 60/433,948, filed on Dec. 16, 2002.

(51) Int. Cl. H04H 1/00

(52) U.S. Cl. 455/3.02

(57) ABSTRACT

A system for recording and playing back data and a karaoke satellite radio receiver and related systems and methods, the recording/playback system includes: (1) a buffer, (2) a recorder controller configured to intercept a data stream during operation of the receiver and store a portion of the data stream in the buffer and (3) a playback switch configured to receive a command that causes the recorder controller to substitute the portion stored in the buffer for the data stream flowing from the demodulator. The latter system includes: (1) a demodulator configured to receive a data channel, (2) a channel selector configured to select at least the channel, (3) a visual display configured to display at least accompanying text and (4) a text manager configured to extract the text from the channel and cause the visual display to display the text in coordination with audio being played by the receiver.

### CROSS-REFERENCE TO RELATED APPLICATION

The present application is based on U.S. Provisional Application Serial No. 60/433,948, filed on Dec. 16, 2002, by Fadavi-Ardekani, et al., entitled “Recording and Playing Back Music/Data While Tuned to Satellite Radio” and commonly assigned with the present invention and application.

### TECHNICAL FIELD OF THE INVENTION

The present invention is directed, in general, to a digital recording and playback devices and, more specifically, to a system and method for recording and playing back music or data while tuned to satellite radio and a karaoke system employing the system or the method.

### BACKGROUND OF THE INVENTION

The last several decades have brought significant changes to broadcast radio technology. First came amplitude modulation (AM) analog radio, then, in turn, frequency modulation (FM) analog radio, FM-AM and FM multiplex stereo analog radio, FM discrete stereo analog radio, FM multiplex quadraphonic analog radio and, finally, AM discrete stereo analog radio. Some of these radio technologies proved longer-lasting than others. Now comes the latest in high-tech broadcast radio: digital satellite radio.

Satellite radio promises to address several perceived limitations with prior forms of broadcast radio. First, all such prior forms are “terrestrial,” meaning that their broadcast signals originate from Earth-bound transmitters. As a result, they have a relatively short range, perhaps a few hundred miles for stations on the AM band, to perhaps only a few tens of miles for stations on the FM band. The frustration wrought on long-distance motorists stemmed, and continues to stem, from constant channel surfing as settled-upon stations slowly fade and new ones slowly come into range.

Second, even within range, radio signals may be attenuated or distorted by natural or man-made obstacles, such as mountains or buildings. Radio signals may even wax or wane in power or fidelity depending upon the time of day or the weather. This only serves to compound the motorists' frustration.

Third, and largely as a consequence of the first limitation, broadcast radio is largely locally originated. This constrains the potential audience that can listen to a particular station and thus the money advertisers are willing to pay for programming and on-air talent. While the trend is decidedly toward large networks of commonly-owned radio stations with centralized programming and higher-paid talent, time and regulatory change will be required to complete the consolidation.

Finally, the Federal Communications Commission (FCC) defined the broadcast radio spectrum decades ago, long before digital transmission, even digital fidelity, were realizable. The result is that the bandwidth allocated to an FM radio station is sub-par for hi-fidelity music, and the bandwidth allocated to an AM radio station is barely adequate for voice.

Satellite radio promises to change all of this. A user who has a satellite radio receiver in his vehicle, home or office (the technology is not limited to mobile applications) can tune into any one of a hundred or more nationwide stations with the promise of compact disc (CD)-quality digital sound and (by virtue of satellite redundancy, transmission from overhead and transcontinental coverage) substantial immunity to service interruption. Satellite technology would appear to do for radio what cable and satellite technologies have done for television.

Satellite radio receivers are on the market, and they have been selling briskly. However, with the exception of the underlying satellite technology and stations, today's receivers offer no more features than does a standard AM/FM radio. Apart from their superior digital sound and the wide array of channels available, they operate much the same as radios have for decades. What is needed in the art is a new satellite radio receiver that truly takes advantage of the underlying digital and satellite technology. What is needed in the art is a satellite radio receiver that gives a user greater control of the data that is streamed to it.

### SUMMARY OF THE INVENTION

To address the above-discussed deficiencies of the prior art, the present invention provides a system for recording and playing back data, a karaoke satellite radio receiver, a karaoke satellite radio service and related and methods.

In one aspect, the present invention provides, for use with a satellite radio receiver having a demodulator and a perceptual decoder, a system for recording and playing back data. The system includes: (b 1) a buffer, (2) a recorder controller, coupled to the buffer, configured to intercept a data stream flowing from the demodulator to the perceptual decoder during operation of the satellite radio receiver and cause a portion of the data stream to be stored in the buffer and (3) a playback switch, coupled to the recorder controller, configured to receive an external command that causes the recorder controller to substitute the portion stored in the buffer for the data stream flowing from the demodulator.

In another aspect, the present invention provides a karaoke satellite radio receiver. The receiver includes: (1) a demodulator configured to receive a plurality of channels, including a data channel, (2) a channel selector, coupled to the demodulator, configured to select at least the data channel, (3) a visual display configured to display at least accompanying text and (4) a text manager, coupled to the visual display, configured to extract the accompanying text from the data channel and cause the visual display to display the accompanying text in coordination with audio being played by the receiver.

In yet another aspect, the present invention provides a karaoke satellite radio service. The service includes: (1) a database of audio data and associated text, (2) a program manager, coupled to the database, configured to select portions of the audio data and associated text from the database for broadcast and (3) a transmitter, coupled to the program manager, configured to transmit a plurality of channels, including a data channel containing at least the associated text and control data that allows a display of the text to be coordinated with a playback of the audio.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of one embodiment of a system for recording and playing back data constructed according to the principles of the present invention;

FIG. 2 illustrates a flow diagram of one embodiment of a method of recording and playing back data carried out according to the principles of the present invention;

FIGS. 3A and 3B illustrate highly schematic block diagrams of alternative embodiments of karaoke satellite radio transmission and reception systems constructed according to the principles of the present invention;

FIG. 4 illustrates a flow diagram of one embodiment of a method of playing karaoke satellite radio carried out according to the principles of the present invention; and

FIG. 5 illustrates a block diagram of one embodiment of a karaoke satellite radio service constructed according to the principles of the present invention.

### DETAILED DESCRIPTION

Referring initially to FIG. 1, illustrated is a block diagram of one embodiment of a system for recording and playing back data constructed according to the principles of the present invention. The system is designed to work in concert with a satellite radio receiver 100 and, in one embodiment, takes advantage of existing receiver 100 hardware. Though those skilled in the pertinent art will be familiar with the general architecture of a satellite radio receiver, the receiver 100 will first be described to set the stage for introducing the system of the present invention.

The receiver 100 comprises a demodulator 110 that receives two identical, but time-shifted, raw data streams from two different satellites (not shown) divided into time domain multiplexed frames. The redundancy inherent in two independent raw data streams and satellites lends reliability to the receiver 100, resulting in little, if any, audio interruptions, or “dead air.”

As stated above, the raw data streams are time-shifted with respect to one another. Thus, the receiver 100 is provided with a satellite signals delay memory 120 that stores, for example, four seconds of the time-advanced raw data stream for use in case the time-delayed raw data stream is compromised. The satellite signals delay memory 120 is large (e.g., 128 Mbits) and fast (e.g., synchronous dynamic random access memory, or SDRAM), because raw data streams are space-consumptive and high rate and because memory is relatively inexpensive. Not only does a raw data stream contain payload data pertaining to all channels that could be selected (on the order of 100 audio or data channels), but the payload data are augmented with error-correcting bits employed to ensure that data corruption or loss is minimized.

The raw data stream is fed from the demodulator 110 or the satellite signals delay memory 120 (as the case may be) to a decoder 130 (which may be a concatenated decoding chain, or CDC) in which it is convolutionally (e.g., Viterbi) decoded and forward (e.g., Reed-Solomon) error-corrected. The result is a partially decoded data stream containing all channels from which a user can select.

Next, a channel selector 140 selects a single channel from the partially decoded data stream emerging from the Decoder 130. The single channel data stream is still perceptually encoded, and so is in a compressed form.

Then, a perceptual decoder 150 perceptually decodes the single channel data stream to yield a completely decoded data stream that is suitable for digital-to-analog conversion, amplification and reproduction on a speaker. A single speaker block 160 represents these last three operations in a shorthand way.

The system of the present invention includes a buffer. Though the buffer may certainly be separate from the satellite signals delay memory 120, it has been found that, even though raw data streams are large, a satellite signals delay memory 120 of nominal 128 Mbit size contains far more space than four seconds' worth of raw data stream could consume. Thus, in the illustrated embodiment of the present invention, the buffer occupies an otherwise unused portion of the satellite signals delay memory 120.

The system further includes a recorder controller 170. The recorder controller is coupled to the buffer (the satellite signals delay memory 120) and is configured to intercept a data stream flowing from the demodulator to the perceptual decoder during operation of the satellite radio receiver.

In the embodiment of FIG. 1, the recorder controller 170 intercepts the partially decoded data stream as it exits the channel selector 140 and heads for the perceptual decoder 150. This interception point is advantageous because only a single channel is contained in the data stream and further because the data stream is still somewhat compressed. Of course, the recorder controller 170 could intercept the data stream at other points along its path, but probably at the cost of additional buffering space that would be required.

The recorder controller 170 causes a portion of the intercepted data stream to be stored in the buffer (the satellite signals delay memory 120). A “portion,” in terms of the illustrated embodiment, means a time-bounded portion (e.g., seconds, minutes or even hours of the data stream, depending upon buffer size). A “portion” may be bounded based on programming, e.g., one or more news segments or songs. A “portion” may encompass multiple channels if the interception occurs before the channel selector 140. A “portion” could be a time-bounded or program-bounded portion of all channels, again at the cost of significant additional buffering.

The system further includes a playback switch 180. The playback switch 180 is coupled to the recorder controller 170 and is configured to receive an external command from a user or another piece of equipment that causes the recorder controller 170 to substitute the portion stored in the buffer for the data stream flowing from the demodulator 110. Thus, the portion is sent to the perceptual decoder 150 and the speaker block 160. The net effect is that the contents of the buffer are played back for the benefit of the user.

In the illustrated embodiment of the present invention, the data stream is an audio stream, perhaps music, to which the user can listen. In response to the user's external command, the recorder controller 170 can cause a stored portion of the data stream to be played back, thereby lending a novel record/playback function to the satellite radio receiver 100. Of course, the data stream does not need to be an audio stream. Any data stream falls within the broad scope of the present invention.

In the illustrated embodiment, the recorder controller 170 is configured to operate continually to cause the portion of the data stream to be stored in the buffer (the satellite signals delay memory 120). Thus, the user is not required to issue an external command to begin or end recording. However, the broad scope of the present invention includes recording upon command.

In the illustrated embodiment, the recorder controller 170 places or pays attention to markers or addresses within the data stream that defines points in the program contained in the data stream. For example, the recorder controller 170 may place a marker between two consecutive songs or may take note of control data already in the data stream indicating a change of song. In either case, the recorder controller 170 may, upon the user's external command, begin substituting the buffered portion at the defined program point. For example, a user may be listening to “Feelings” and decide to listen to that favorite song again from the start. Upon receiving an external playback command, the recorder controller 170 begins to substitute the buffered portion beginning at the starting point of the song.

Certain embodiments described below are directed to karaoke satellite radio receivers. The receiver 100 can accommodate this operation when the data stream includes audio data and coordinated lyrics data, either in separate audio and data channels or a single data channel. The record/playback function of the receiver 100 is advantageous if a user wishes to repeat his operatic performance.

Finally, the system includes an external memory interface (EMI) 190. The EMI 190 is coupled to the recorder controller 170 and is configured to receive the portion stored in the buffer and transfer that portion to an external memory 195, such as a flash memory card or stick, for more permanent storage or use in a separate system.

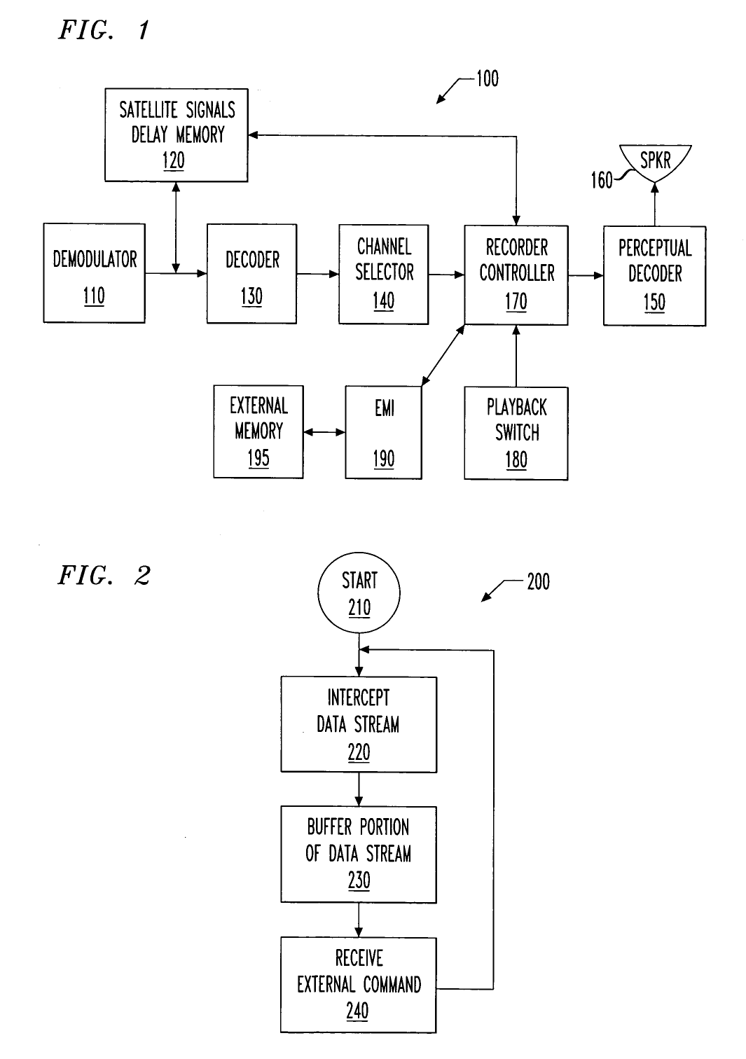

Turning now to FIG. 2, illustrated is a flow diagram, generally designated 200, of one embodiment of a method of recording and playing back data carried out according to the principles of the present invention. The method 200 begins in a start step 210 wherein a satellite radio receiver has begun to operate, and a data stream has begun to flow from the demodulator (and, in the illustrated embodiment, the channel selector).

In a step 220, the data stream flowing from the demodulator (and channel selector) to the perceptual decoder is intercepted (continually in the illustrated embodiment) during operation of the satellite radio receiver. Next, in a step 230, a portion of the data stream is buffered (in the satellite signals delay memory in the illustrated embodiment).

Then, in a step 240, an external command is received. The external command causes the recorder controller to substitute the portion stored in the buffer for the data stream flowing from the demodulator, thereby effecting a playback of some or all of the stored portion of the data stream. The method 200 doubles back to the step 220, as recording resumes or continues. In the illustrated embodiment, recording continues even during playback (by interleaving memory operations with respect to the buffer).

The possibility of a karaoke satellite radio receiver was briefly discussed above. Now, the structure and operation of that receiver will be discussed in greater detail.

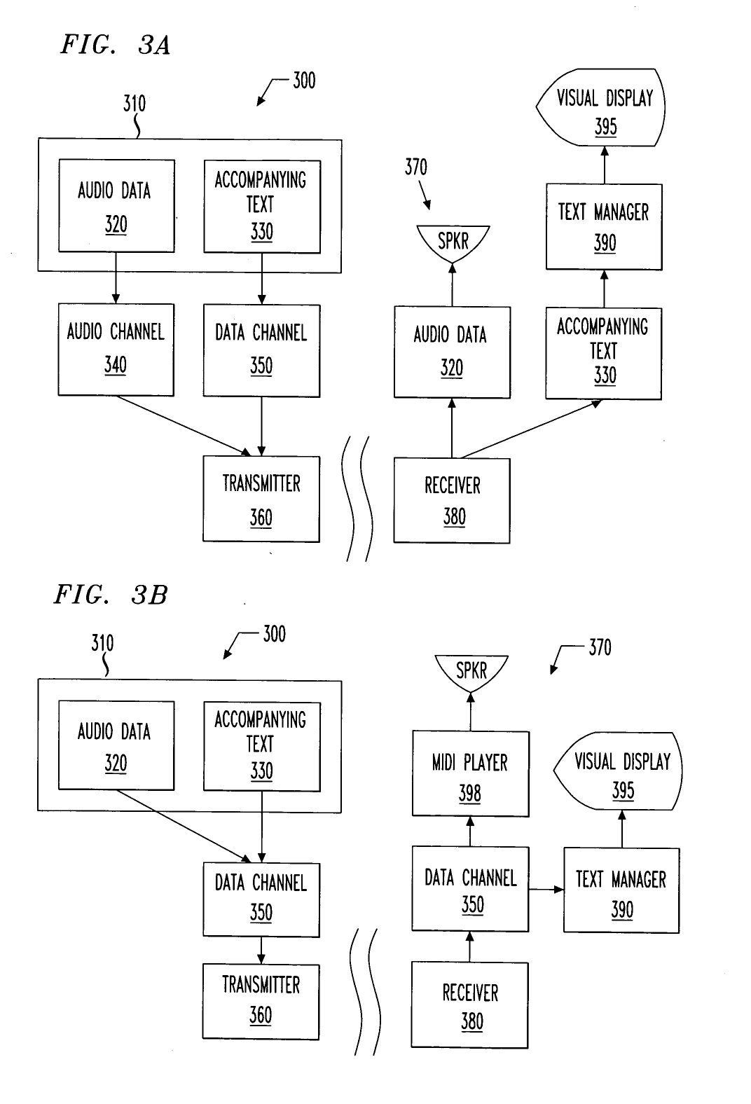

Turning to FIGS. 3A and 3B, illustrated are highly schematic block diagrams of alternative embodiments of karaoke satellite radio transmission and reception systems constructed according to the principles of the present invention. Before proceeding, a brief explanation of karaoke may be in order.

Karaoke is an activity originating and named in Japan, that involves singing along with music. While the music plays, coordinated accompanying lyrics appear on a display, much like the “bouncing ball” singalong films of 50 years ago. To enhance the singer's operatic contribution, the music is almost always instrumental.

While karaoke began in bars and no doubt benefited greatly from the lubricating effects of alcohol, its popularity has spread to the extent that standalone karaoke machines have for years been available for both home and office use. These less expensive consumer machines allow the reticent to sing alone or only in the company of small groups of friends who are more inclined to understand and forgive. Since many people have the good judgment to sing only when they are alone, karaoke appears to be ideally suited for introduction into a vehicle.

FIG. 3A illustrates a first embodiment of a karaoke satellite radio transmission and reception system employing separate audio and data channels. The transmission system, generally designated 300, comprises a database 310 that contains audio data 320 in a conventional or later-defined format (e.g., wave or MP3 encoded). The database 310 or another database (the number or type of databases is immaterial) contains accompanying text 330. The accompanying text 330 includes control data (not separately referenced) that will serve to coordinate its display with the audio data 320.

The audio data 320 are provided to an audio channel 340, and the accompanying text 330 is provided to a data channel 350. The audio channel 340 and the data channel 350 are combined with further channels into a single data stream in a conventional manner and provided to a satellite transmitter 360.

The data stream is uplinked to a satellite and downlinked to a reception system, generally designated 370. There, the audio channel 340 and the data channel 350 are received by a receiver 380, separated and both channel-selected for concurrent play. The resulting audio data 320 are played on one or more speakers (not referenced), and, under control of a text manager 390 (which uses the control data to coordinate), the accompanying text 330 is displayed on a visual display 395 capable of displaying at least the accompanying text 330. Although not shown, the reception system 370 may include a microphone and an analog-to-digital converter to allow the user to add his voice to the audio data 320.

FIG. 3B illustrates a second embodiment of a karaoke satellite radio transmission and reception system employing a common data channel to provide both audio and accompanying text. The transmission system 300 comprises the database 310 that contains the audio data 320 now in what is likely to be a highly compressed format (e.g., musical instrument device interface, or MIDI commands) given that it must share a single data channel. The database 310 or another database (again, the number or type of databases is immaterial) contains the accompanying text 330, again including control data. The audio data 320 and the accompanying text 330 are combined in a multiplexer 335 into the single data channel 350. The data channel 350 is combined with further channels into a single data stream in a conventional manner and provided to the satellite transmitter 360.

The data stream is uplinked to a satellite and downlinked to the reception system 370. There, the data channel 350 is selected for play. The resulting audio data 320 are in all likelihood provided to a MIDI player 398 for synthesizing audio and then played on one or more speakers (not referenced), and, under control of the text manager 390 (which uses the control data to coordinate), the accompanying text 330 is displayed on the visual display 395. Again, the reception system 370 may include a microphone and an analog-to-digital converter to allow the user to add his voice to the audio data 320.

As an aside, it should be clear that the audio data need not be music. It could be speech or other sounds, in which case the accompanying text might be a translation or further explanation (e.g., parentheticals or footnotes). Even in the case of music, the accompanying text need not be lyrics.

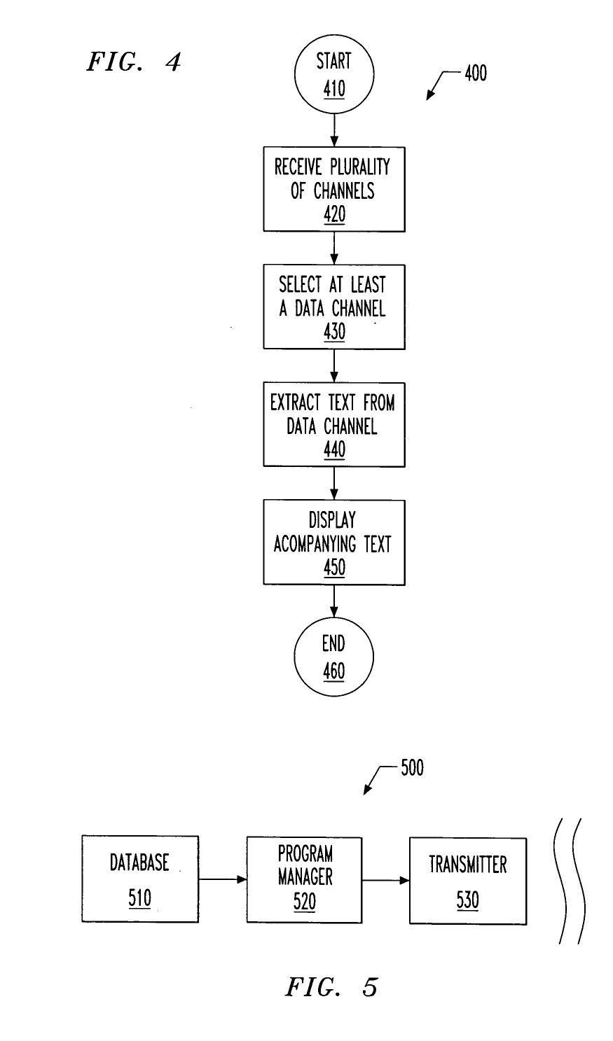

Turning now to FIG. 4, illustrated is a flow diagram of one embodiment of a method, generally designated 400, of playing karaoke satellite radio carried out according to the principles of the present invention. The method 400 begins in a start step 410, in which it is desired to sing a song, perhaps the endearing “You Light Up My Life.”

The method 400 proceeds to a step 420, in which a plurality of channels, including a data channel, are received. Then, in a step 430, at least the data channel is selected. (In alternative embodiments corresponding to FIGS. 3A and 3B, both the data channel and an associated audio channel are selected or only the data channel is selected.) Next, in a step 440, accompanying text is extracted from the at least the data channel. Then, in a step 450, the visual display is caused to display the accompanying text in coordination with audio being played by the receiver. The method ends in an end step 460, the user having uniquely enjoyed his rendition.

More should be written about the commercial service that would provide such audio data and accompanying text to the karaoke satellite radio receiver and simultanteously to other such receivers. Accordingly, turning now to FIG. 5, illustrated is a block diagram of one embodiment of a karaoke satellite radio service, generally designated 500, constructed according to the principles of the present invention.

The karaoke satellite radio service 500 includes a database (of any type or configuration) of audio data and accompanying text 510, with control data. A program manager 520 is coupled to the database 510. The program manager is configured to select portions of the audio data and accompanying text from the database for broadcast. The program manager 520 may actually select the karaoke program to be offered or may simply retrieve karaoke songs in response to a preprogrammed playlist (not shown). A transmitter 530 is coupled to the program manager 520 and is configured to transmit a plurality of channels, including a data channel containing at least the accompanying text and control data that allows a display of the text to be coordinated with a playback of the audio. As above, the transmitter 530 may provide the audio data on an audio channel separate from the data channel. Alternatively, the transmitter 530 may include the audio data in the data channel.

Although the present invention has been described in detail, those skilled in the art should understand that they can make various changes, substitutions and alterations herein without departing from the spirit and scope of the invention in its broadest form.

What is claimed is:

1. For use with a satellite radio receiver having a demodulator and a perceptual decoder, a system for recording and playing back data, comprising:
a buffer;
a recorder controller, coupled to said buffer, configured to intercept a data stream flowing from said demodulator to said perceptual decoder during operation of said satellite radio receiver and cause a portion of said data stream to be stored in said buffer; and
a playback switch, coupled to said recorder controller, configured to receive an external command that causes said recorder controller to substitute said portion stored in said buffer for said data stream flowing from said demodulator.

2. The system as recited in claim 1 wherein said data stream comprises audio data and coordinated lyrics data.

3. The system as recited in claim 1 wherein said buffer is embodied in a portion of a satellite signals delay memory.

4. The system as recited in claim 1 wherein said recorder controller is configured to operate continually to cause said portion of said data stream to be stored in said buffer.

5. The system as recited in claim 1 wherein said satellite radio receiver further has a channel selector and said portion of said data stream is a single channel.

6. The system as recited in claim 1 wherein said external command causes said recorder controller to substitute said portion stored in said buffer beginning at a defined program point.

7. The system as recited in claim 1 further comprising an external memory interface, coupled to said recorder controller, configured to receive said portion stored in said buffer.

8. For use with a satellite radio receiver having a demodulator and a perceptual decoder, a method of recording and playing back data, comprising:
intercepting a data stream flowing from said demodulator to said perceptual decoder during operation of said satellite radio receiver;
buffering a portion of said data stream; and
receiving an external command that causes said recorder controller to substitute said portion stored in said buffer for said data stream flowing from said demodulator.

9. The method as recited in claim 8 wherein said buffering is carried out in a portion of a satellite signals delay memory.

10. The method as recited in claim 8 wherein said buffering is performed continually.

11. The method as recited in claim 8 further comprising:
selecting a channel from said data stream; and
only buffering said channel.

12. The method as recited in claim 8 wherein said external command causes said substituting to begin at a defined program point in said portion.

13. The method as recited in claim 8 further comprising transmitting said portion to an external memory interface.

14. A karaoke satellite radio receiver, comprising:
a demodulator configured to receive a plurality of channels, including a data channel;
a channel selector, coupled to said demodulator, configured to select at least said data channel;
a visual display configured to display at least accompanying text; and
a text manager, coupled to said visual display, configured to extract said accompanying text from said data channel and cause said visual display to display said accompanying text in coordination with audio being played by said receiver.

15. The receiver as recited in claim 14 further comprising:
a buffer;
a recorder controller, coupled to said demodulator and said buffer, configured to intercept said data channel flowing from said demodulator during operation of said receiver and cause a portion of said data channel to be stored in said buffer; and
a playback switch, coupled to said recorder controller, configured to receive an external command that causes said recorder controller to substitute said portion stored in said buffer for said data channel flowing from said demodulator.

16. The receiver as recited in claim 14 wherein said channel selector is configured to select both said data channel and an associated audio channel, said audio channel providing said audio.

17. The receiver as recited in claim 14 wherein said channel selector is configured to select only said data channel, said data channel including audio data, said audio data being decoded to provide said audio.

18. The receiver as recited in claim 14 wherein said accompanying text is lyrics and said audio is music.

19. The receiver as recited in claim 14 wherein said data channel comprises musical instrument device interface (MIDI) synthesizer commands.

20. A method of playing karaoke satellite radio, comprising:
receiving a plurality of channels, including a data channel;
selecting at least said data channel;
extracting accompanying text from said at least said data channel; and
causing said visual display to display said accompanying text in coordination with audio being played by said receiver.

21. The method as recited in claim 20 wherein said selecting comprises selecting both said data channel and an associated audio channel, said audio channel providing said audio.

22. The method as recited in claim 20 wherein said selecting comprises selecting only said data channel, said data channel including audio data, said audio data being decoded to provide said audio.

23. The method as recited in claim 20 wherein said accompanying text is lyrics and said audio is music.

24. The method as recited in claim 20 further comprising responding to musical instrument device interface (MIDI) synthesizer commands to play said audio.

25. A karaoke satellite radio service, comprising:
a database of audio data and accompanying text;
a program manager, coupled to said database, configured to select portions of said audio data and accompanying text from said database for broadcast; and
a transmitter, coupled to said program manager, configured to transmit a plurality of channels, including a data channel containing at least said accompanying text and control data that allows a display of said text to be coordinated with a playback of said audio.

26. The service as recited in claim 25 wherein said transmitter provides said audio data on an audio channel separate from said data channel.

27. The service as recited in claim 25 wherein said transmitter includes said audio data in said data channel.
